(19) United States
(12) Patent Application Publication
(10) Pub. No.: US 2009/0147098 A1
(43) Pub. Date: Jun. 11, 2009

(54) IMAGE SENSOR APPARATUS AND METHOD FOR COLOR CORRECTION WITH AN ILLUMINANT-DEPENDENT COLOR CORRECTION MATRIX

(75) Inventor: Zhaojian Li, Sunnyvale, CA (US)

Correspondence Address: Curtis A. Vock;LATHROP & GAGE LLP, 4845 Pearl East Circle, Suite 201, Boulder, CO, 80301, US

(73) Assignee: OmniVision Technologies, Inc., Sunnyvale, CA (US)

(21) Appl. No.: 11/953,776

(22) Filed: Dec. 10, 2007

(51) Int. Cl. H04N 9/73

(52) U.S. Cl. 348/223.1; 348/E11.001

(57) ABSTRACT

An image sensor apparatus is disclosed. The image sensor apparatus includes an image sensor for generating pixel data corresponding to a scene under a scene illuminant. The image sensor apparatus also includes a memory for storing color correction information corresponding to a subset of candidate illuminants. A color correction module in the image sensor apparatus derives an illuminant-dependent color correction matrix based on the color correction information corresponding to the subset of candidate illuminants and applies the illuminant-dependent color correction matrix to the pixel data to generate a color corrected digital image.

### BRIEF DESCRIPTION OF THE INVENTION

This invention relates generally to color correction in image sensor devices. More particularly, this invention relates to an image sensor apparatus and method for color correction with an illuminant-dependent color correction matrix.

### BACKGROUND OF THE INVENTION

Image sensors are semiconductor devices that capture and process light into electronic signals for forming still images or video. Their use has become prevalent in a variety of consumer, industrial, and scientific applications, including digital cameras and camcorders, hand-held mobile devices, webcams, medical applications, automotive applications, games and toys, security and surveillance, pattern recognition, and automated inspection, among others. The technology used to manufacture image sensors has continued to advance at a rapid pace.

There are two main types of image sensors available today: Charge-Coupled Device (“CCD”) sensors and Complementary Metal Oxide Semiconductor (“CMOS”) sensors. In either type of image sensor, a light gathering photosite is formed on a semiconductor substrate and arranged in a two-dimensional array. The photosites, generally referred to as picture elements or “pixels,” convert the incoming light into an electrical charge. The number, size, and spacing of the pixels determine the resolution of the images generated by the sensor.

Modern image sensors typically contain millions of pixels in the pixel array to provide high-resolution images. The image information captured in each pixel, e.g., raw pixel data in the Red, Green, and Blue (“RGB”) color space, is transmitted to an Image Signal Processor (“ISP”) or other Digital Signal Processor (“DSP”) where it is processed to generate a digital image.

The quality of the digital images generated by an image sensor depends mostly on its sensitivity and a host of other factors, such as lens-related factors (flare, chromatic aberration), signal processing factors, time and motion factors, semiconductor-related factors (dark currents, blooming, and pixel defects), and system control-related factors (focusing and exposure error, white balance error). White balance error, for example, causes poor color reproduction and can easily deteriorate image quality if not corrected for.

White balance in an image sensor device refers to the adjustment of the primary colors e.g., Red, Green, and Blue, in images captured by the device so that a captured image that appears white for the device also appears white for the Human Visual System (“HVS”). The discrepancy in colors perceived by an image sensor device and the HVS arises out of the many light sources available and their different color temperatures. While the HVS is proficient in adapting to different light sources illuminating a scene, commonly referred to as the scene illuminants, image sensors are not capable of accurately capturing color in all color temperatures. For example, a white paper may be captured by an image sensor as slightly reddish under a household light bulb or as bluish under daylight. The same white paper is perceived as white by the HVS under different scene illuminants.

To emulate the HVS, white balance must be performed in image sensor devices. In addition, image sensor devices must also perform color correction in order to improve the accuracy of color reproduction. Color correction is required because the spectral sensitivity of imagine sensors differs from the color matching functions of the HVS. The RGB values generated by image sensor devices are also device-dependent, i.e., different devices produce different RGB responses for the same scene.

In order to preserve color fidelity or teach an image sensor device how to see as the HVS expects colors to look, color correction is performed to establish the relationship between device-dependent RGB values and device-independent values. The device-independent values are calculated on the “CIE XYZ” color space, which is based on the International Commission on Illumination (“CIE”) standard observer color-matching functions.

The transformation from device-dependent RGB values into device-independent values is usually achieved through linear transformation with a N×M color correction matrix, where N corresponds to the dimension of the device-dependent color space (e.g., 3) and M corresponds to the dimension of the device-independent color space (e.g., 3). The color correction matrix contains coefficients for transforming the device-dependent values into the device-independent values. The color correction matrix is stored in the image sensor device and applied to each image captured by the device.

Typically, the color correction matrix stored in the image sensor device is optimized for a single hypothetical scene illuminant. If the actual scene illuminant is different than the hypothetical one, color reproduction will suffer. For white balance and color correction to be performed accurately on image sensor devices, the scene illuminant must be known. In general, there are two ways to obtain the scene illuminant information: measuring the color of the scene illuminant and estimating it from captured images. Regardless of the approach, each scene illuminant may be associated with a different illuminant-dependent color correction matrix.

Once the scene illuminant is estimated, color correction may be performed with its corresponding color correction matrix. Using illuminant-dependent color correction matrices to perform color correction can achieve higher accuracy of color reproduction than that using a single color correction matrix optimized for a hypothetical illuminant.

Although this approach achieves good color reproduction, it is time consuming, computationally intensive, and requires significant storage. The scene illuminant may have to be estimated for each captured image. In addition, color correction matrices for a range of illuminants have to be generated and stored for each image sensor device. Depending on the number of illuminants that are used, this could add significant storage and computational costs to image sensor devices. With device manufacturers pushing for lower costs and higher quality, there is a need to provide as accurate color correction as possible without draining the device resources.

Accordingly, it would be desirable to provide an apparatus and method for estimating an illuminant-dependent color correction matrix that is capable of achieving high performance of color correction with low storage and computational requirements.

### SUMMARY OF THE INVENTION

An image sensor apparatus has an image sensor for generating pixel data corresponding to a scene under a scene illuminant. The image sensor apparatus also has a memory for storing color correction information corresponding to a subset of candidate illuminants. A color correction module in the image sensor apparatus derives an illuminant-dependent color correction matrix based on the color correction information corresponding to the subset of candidate illuminants and applies the illuminant-dependent color correction matrix to the pixel data to generate a color corrected digital image.

An embodiment of the invention includes a method for color correction in an image sensor device. Pixel data corresponding to a scene under a scene illuminant is generated. An illuminant-dependent color correction matrix is derived based on color correction information corresponding to a subset of candidate illuminants. The illuminant-dependent color correction matrix is applied to white balanced pixel data to generate a color corrected digital image.

Another embodiment of the invention includes a processor for use in an image sensor device. The processor has a white balance routine for determining a white balance gain for pixel data captured by the image sensor device under a scene illuminant. The processor also has a color correction routine for deriving an illuminant-dependent color correction matrix corresponding to the scene illuminant and based on color correction information corresponding to a subset of candidate illuminants.

### BRIEF DESCRIPTION OF THE DRAWINGS

The invention is more fully appreciated in connection with the following detailed description taken in conjunction with the accompanying drawings, in which like reference characters refer to like parts throughout, and in which:

FIG. 1 illustrates an image sensor apparatus constructed according to an embodiment of the invention;

FIG. 2 illustrates a flow chart for color correction in an image sensor apparatus according to an embodiment of the invention;

FIG. 3 illustrates a flow chart for generating a color correction matrix corresponding to a given illuminant according to an embodiment of the invention;

FIG. 4 illustrates a schematic diagram for generating a color correction matrix corresponding to a given illuminant according to an embodiment of the invention:

FIG. 5 illustrates exemplary color correction matrices corresponding to five candidate illuminants according to an embodiment of the invention;

FIG. 6 illustrates a graph showing white balance gains corresponding to the color correction matrices of FIG. 5 according to an embodiment of the invention;

FIG. 7 illustrates graphs of color correction coefficients and white balance gains corresponding to various illuminants according to an embodiment of the invention;

FIG. 8 illustrates the interpolation of color correction coefficients corresponding to a subset of candidate illuminants according to an embodiment of the invention; and

FIGS. 9A-C illustrate the color accuracy performance of illuminant-dependent color correction matrices derived according to an embodiment of the invention for three test illuminants.

### DETAILED DESCRIPTION OF THE INVENTION

An image sensor apparatus for color correction with an illuminant-dependent color correction matrix is provided. An image sensor, as generally used herein, may be a semiconductor circuit having an array of pixels for capturing and processing an optical image of a scene into electronic signals in the form of pixel data. The apparatus includes a color correction module for generating the illuminant-dependent color correction matrix and applying the matrix to pixel data captured by an image sensor to output a color corrected digital image.

As generally used herein, a color correction matrix is a two-dimensional N×M matrix of color correction coefficients for converting device-dependent values into device-independent values, where N corresponds to the dimension of the device-dependent color space (e.g., 3 for an RGB color space) and M corresponds to the dimension of the device-independent color space (e.g., 3 for an RGB or CIE XYZ color space). The color correction matrix may be stored in the image sensor apparatus and applied to each image captured by the image sensor to generate color corrected digital images.

Each image captured by the image sensor is captured under a scene illuminant. A scene illuminant, as generally used herein, may be any illuminating source providing light for the scene, for example, natural daylight, ambient office or household light, street light, and so on. Scene illuminants may include, for example, the standard illuminants published by the International Commission on Illumination (“CIE”). Common standard illuminants include illuminant A (incandescent tungsten lighting), illuminant series C (average or north sky daylight), illuminant series D (various forms of daylight), and illuminant series F (fluorescent lighting).

According to an embodiment of the invention, the scene illuminant may not be known by the image sensor. To provide good color reproduction, an illuminant-dependent color correction matrix is used. The illuminant-dependent color correction matrix is generated without having to estimate the unknown scene illuminant. Rather, in one embodiment, the illuminant-dependent color correction matrix is generated from color correction information corresponding to a subset of candidate illuminants.

In one embodiment, the color correction information is selected to correspond to two significantly different illuminants, e.g., illuminants having significantly different color temperatures. The color correction information corresponding to the subset of candidate illuminants may be, for example, two color correction matrices and two white balance gains corresponding to the two candidate illuminants.

According to an embodiment of the invention, the color correction matrices corresponding to the subset of candidate illuminants are generated in an iterative process. At each step of the iterative process, the color coefficients of a color correction matrix for a given candidate illuminant are adjusted to minimize color differences between measured chromaticity data and color corrected data for a training set under the candidate illuminant. The training set may be, for example, a checkerboard of colors, such as the GretagMacbeth ColorChecker available from X-Rite, Inc., of Grand Rapids, Mich.

The chromaticity measurements may be, for example, measurements of CIE XYZ coordinates corresponding to the training set under the given candidate illuminant. The color corrected pixel data is generated at each step by applying the color correction matrix being adjusted to pixel data captured for the training set under the given candidate illuminant. The color differences may be computed, for example, based on the CIEDE2000 color difference formula.

According to an embodiment of the invention, a linear relationship between color correction coefficients and white balance gains for the subset of candidate illuminants is identified. The illuminant-dependent color correction matrix is generated via interpolation of the color correction matrices corresponding to the subset of candidate illuminants, as described in more detail herein below.

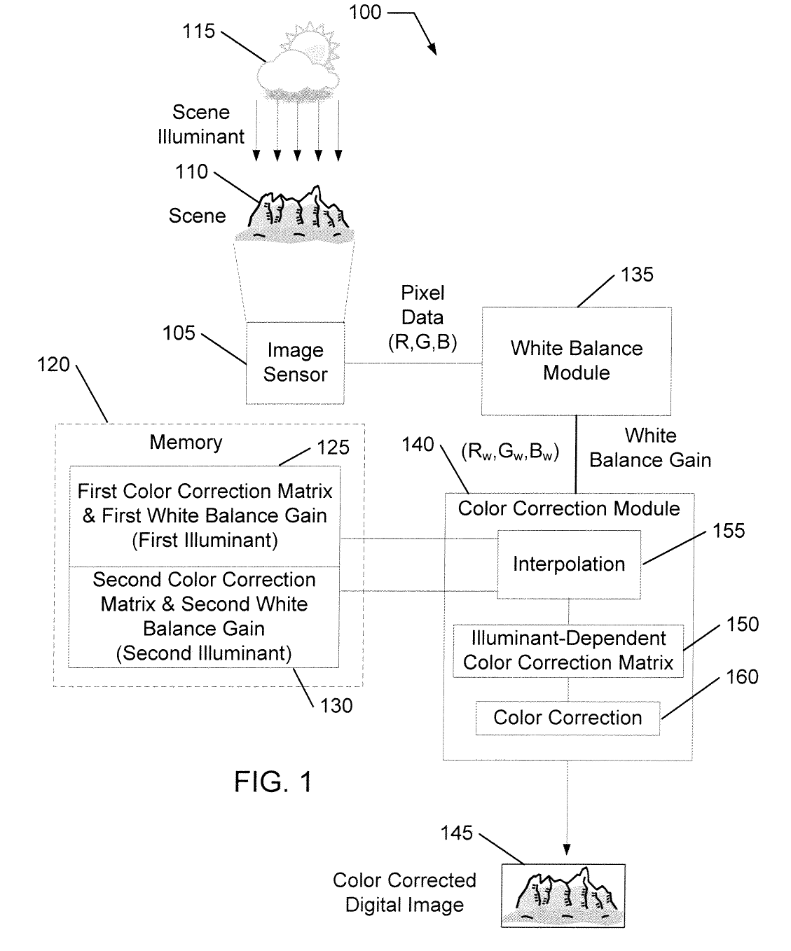

An image sensor apparatus constructed according to an embodiment of the invention is illustrated in FIG. 1. Image sensor apparatus 100 includes image sensor 105 for capturing an optical image of a scene, e.g., scene 110, under a scene illuminant, e.g., scene illuminant 115. Image sensor apparatus 100 also includes memory 120 for storing color correction information corresponding to a subset of candidate illuminants.

In one embodiment, the subset of candidate illuminants may include at least two significantly different illuminants, such as, for example, the illuminant D65 representing fluorescent daylight and the illuminant A representing incandescent tungsten light. The color correction information corresponding to the two significantly different illuminants stored in memory 120 may include, for example, a first color correction matrix and a first white balance gain 125 for a first candidate illuminant (e.g., illuminant D65) and a second color correction matrix and a second white balance gain 130 for a second candidate illuminant (e.g., illuminant F2).

According to an embodiment of the invention, image sensor apparatus 100 also includes a white balance module 135 for performing white balancing on pixel data captured by image sensor 105 and a color correction module 140 for performing color correction on the white balanced pixel data to generate a color corrected digital image, e.g., image 145. Color correction module 140 generates an illuminant-dependent color correction matrix 150 by interpolating the color correction information 125-130 stored in memory 120, as described in more detail herein below.

An interpolation module 155 within color correction module 140 generates the illuminant-dependent color correction matrix 150 from a white balance gain computed for the pixel data captured by image sensor 105 in white balance module 135 and from the two color correction matrices and corresponding two white balance gains 125-130 stored in memory 120. The interpolation performed may include linear interpolation, linear extrapolation, or other curve fitting or statistical trend analysis algorithm.

The illuminant-dependent color correction matrix 150 is applied to the pixel data captured by image sensor 105 in color correction sub-module 160 to generate the color corrected digital image 145. Color correction sub-module 160 performs a matrix multiplication between the illuminant-dependent color correction matrix 150 and the white balanced pixel data captured by image sensor 105 to generate the color corrected digital image 145.

In one embodiment, illuminant-dependent color correction matrix 150 may be a N×M color correction matrix, where N corresponds to the dimension of the device-dependent color space used by image sensor 105 (e.g., 3 for an RGB color space) and M corresponds to the dimension of a device-independent color space (e.g., 3 for an RGB or CIE XYZ color space). For example, the matrix multiplication performed by color correction sub-module 160 may involve a matrix multiplication between a 3×3 illuminant-dependent color correction matrix and a 3×L pixel data matrix, where L corresponds to the dimension of the pixel array in image sensor 105. For example, L may correspond to a 1280×1024 pixel array for a 1.3 Megapixels image sensor.

One of ordinary skill in the art appreciates that a demosaicing module (not shown) is also included in image sensor apparatus 100 for extracting raw (R,G,B) pixel data from the raw data captured by image sensor 105. Further, it is appreciated that illuminant-dependent color correction matrix 150 may be generated based on color correction information corresponding to more than two candidate illuminants. Using two candidate illuminants provide good color reproduction without sacrificing computational and storage resources. Using additional candidate illuminants may slightly improve the color reproduction performance with the expense of additional storage and computational resources. Additionally, it is appreciated that the illuminant-dependent color correction matrix 150 is generated without having to estimate the scene illuminant 115, in contrast to traditional approaches.

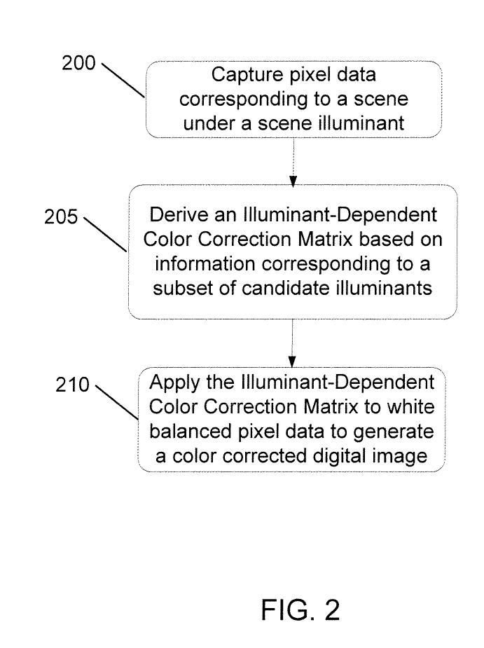

Referring now to FIG. 2, a flow chart for color correction in an image sensor apparatus according to an embodiment of the invention is described. First, in step 200, pixel data corresponding to a scene under a scene illuminant is captured by image sensor 105. Next, in step 205, an illuminant-dependent color correction matrix based on color correction information corresponding to a subset of candidate illuminants is derived.

The illuminant-dependent color correction matrix is derived by interpolating color correction matrices corresponding to the subset of candidate illuminants, as described in more detail herein below. The subset of candidate illuminants may include at least two candidate illuminants. In one embodiment, the subset of candidate illuminants is chosen to include significantly different candidate illuminants, e.g., having significantly different color temperatures.

Lastly, in step 210, the illuminant-dependent color correction matrix is applied to white balanced pixel data to generate a color corrected digital image. As appreciated by one of ordinary skill in the art, this involves a matrix multiplication between the illuminant-dependent color correction matrix and the white balanced pixel data.

It is also appreciated that the color corrected digital image achieves good color reproduction with a simple and computationally and storage efficient approach. The color corrected digital image is generated with simple interpolation, matrix computation, and the storage of color correction information corresponding to a subset of candidate illuminants, e.g., two color correction matrices and two white balance gains corresponding to two candidate illuminants. The color correction information corresponding to a subset of candidate illuminants is predetermined and stored in memory, e.g., memory 120.

In one embodiment, the color correction matrices corresponding to the subset of candidate illuminants are generated based on a training set. The training set is illuminated with the subset of candidate illuminants and sensed by image sensor 105 to capture pixel data. The pixel data is then color corrected with a color correction matrix that is adjusted iteratively to minimize color differences between the color corrected pixel data and measured chromaticity data for the training set, as described below.

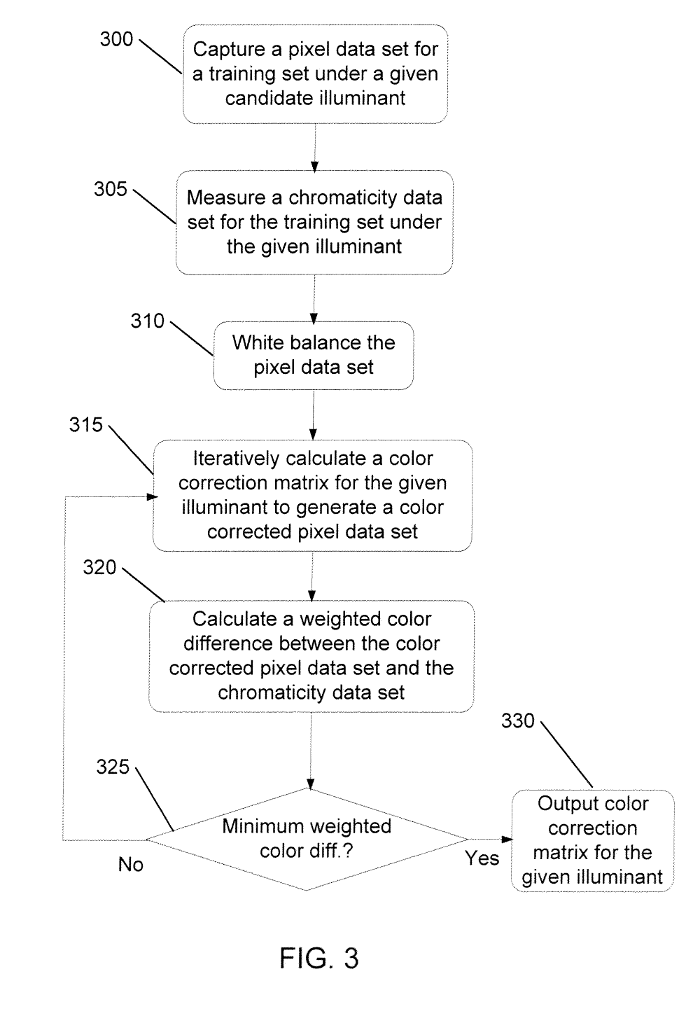

Referring now to FIG. 3, a flow chart for generating a color correction matrix corresponding to a candidate illuminant according to an embodiment of the invention is described. First, in step 300, pixel data (e.g., raw RGB data) for the training set under the candidate illuminant is captured by image sensor 105 for a training set. The training set may be, for example, an image of a checkerboard of colors, such as the GretabMacbeth ColorChecker available from X-Rite, Inc., of Grand Rapids, Mich. Chromaticity data for the checkerboard of colors under the candidate illuminant is measured in step 305. The chromaticity data may include, for example, CIE XYZ coordinates corresponding to the checkerboard of colors under the given candidate illuminant.

The color correction matrix corresponding to the candidate illuminant is calculated in an iteratively process in step 315 after white balancing the pixel data set in step 310. First, the color correction matrix is initialized. The matrix may be initialized with any color coefficient values, for example, color coefficients that are traditionally used for illuminant-independent color correction matrices stored in image sensor device or known color coefficients corresponding to a given illuminant, e.g., D65. Then, in each step 315 of the iterative process, the color coefficients in the matrix are adjusted to generate a color corrected pixel data set. That is, the white balanced pixel data set generated in step 310 is multiplied by the color correction matrix to generate the color corrected pixel data set. In one embodiment, the color correction matrix may be a 3×3 matrix for converting the pixel data into the color corrected pixel data.

The iterations are dictated by calculations of a color difference measure between the measured CIE XYZ and the color corrected pixel data set in step 320. In one embodiment, the color corrected pixel data set may be converted into the CIE XYZ space prior to computing the color difference measure. The color difference measure may be, for example, a weighted color difference measure between the measured CIE XYZ chromaticity data and the color corrected CIE XYZ pixel data, such as the CIEDE2000 color difference formula or other such color difference formula.

An evaluation is made in step 325 to determine whether the calculated color difference between the measured CIE XYZ data and the color corrected CIE XYZ data has reached its minimum. If not, the iterative process returns to step 315 where the color correction matrix is adjusted to proceed with additional iterations until the calculated color difference has reached its minimum. When that occurs, the final color correction matrix for the candidate illuminant is generated in step 330.

One of ordinary skill in the art appreciates that color correction matrices for various candidate illuminants are generated according to the steps of FIG. 3. However, the matrices are generated only for the purposes of selecting a subset of color correction matrices corresponding to a subset of the candidate illuminants. The subset of color correction matrices are to be stored in memory 120 of image sensor apparatus 100 for estimating an illuminant-dependent color correction matrix on the fly every time a new image is captured by image sensor 105.

As described above, the subset of candidate illuminants include at least two significantly different candidate illuminants, such as the illuminant D65 representing fluorescent daylight and the illuminant A representing incandescent tungsten lighting. Accordingly, only two color correction matrices may be stored in memory 120 for estimating an illuminant-dependent color correction matrix. The scene illuminant itself does not have to estimated, thereby providing considerable savings in storage and computational resources.

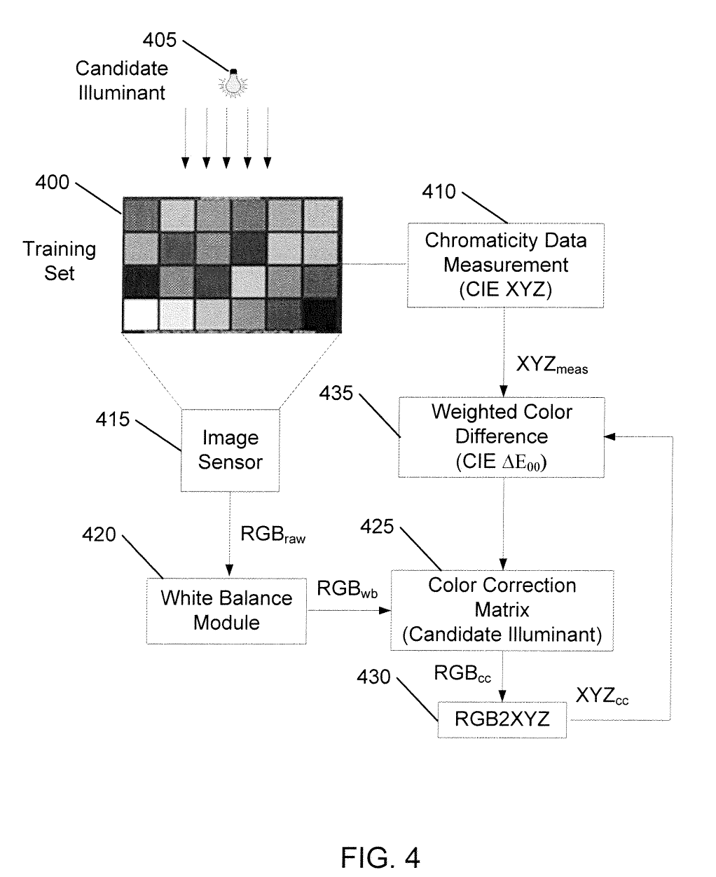

Referring now to FIG. 4, schematic diagram illustrating the steps of FIG. 3 for generating a color correction matrix corresponding to a given candidate illuminant according to an embodiment of the invention is described. Training Set 400, which includes an image of a checkerboard of colors, is illuminated with candidate illuminant 405. Chromaticity data 410, e.g., CIE XYZ data, is measured from training set 400. Raw pixel data is acquired by image sensor 415. As described herein above, the raw pixel data acquired by image sensor 415 must be color corrected to achieve a good color reproduction in the output image.

Accordingly, the raw pixel data is first white balanced in white balance module 420 to generate white balanced data. The white balanced data is multiplied by an initialized illuminant-dependent color correction matrix 425 to generate color corrected pixel data. Illuminant-dependent color correction matrix 425 is generated iteratively until the color differences between the color corrected pixel data and the measured chromaticity data are minimized. In one embodiment, the color corrected pixel data is converted into the CIE XYZ color space in color space conversion module 430 prior to the computation of the color differences.

The color differences between the measured CIE XYZ data and the color corrected CIE XYZ data are computed in module 435. Module 435 calculates a weighted color difference measure, such as the CIEDE2000 measure, between the measured and the color corrected CIE XYZ data. Illuminant-dependent color correction matrix 425 is adjusted until the calculated color differences are minimized.

One of ordinary skill in the art appreciates that any optimization algorithm may be used to find the minimum color differences, such as, for example, the Newton's method, the Simplex method, the Gradient Descent method, and so on. One of ordinary skill in the art appreciates that the convergence of the optimization algorithm may depend on how the illuminant-dependent color correction matrix is initialized. Because the color correction matrices that are ultimately stored in image sensor apparatus 100 are predetermined, the convergence of the algorithm does not affect the color correction process in image sensor apparatus 100. That is, any computational resources used for creating the color correction matrices stored in image sensor apparatus 100 are used only once at the time the matrices are created.

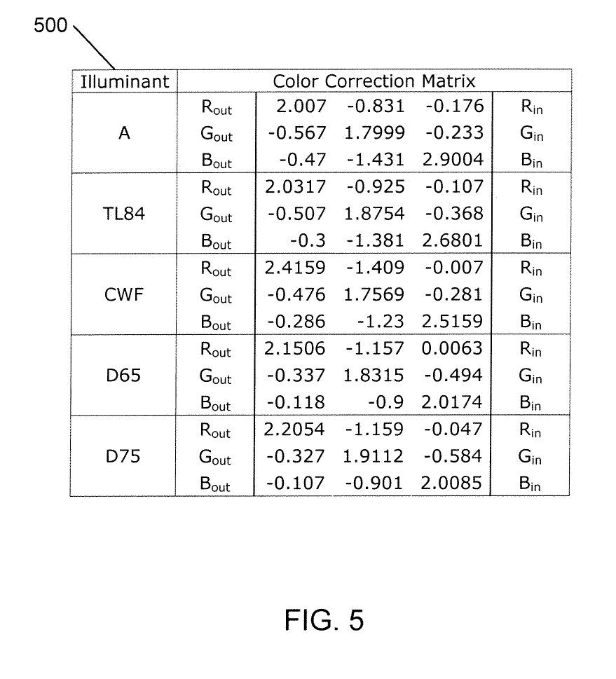

Referring now to FIG. 5, exemplary color correction matrices corresponding to five candidate illuminants according to an embodiment of the invention are described. Table 500 shows color correction matrices derived according to the steps in FIGS. 3-4 for the following candidate illuminants: illuminant A; illuminant TL84; illuminant CWF; illuminant D65; and illuminant D75. All the color correction matrices have different color coefficients, further reiterating the importance of performing color correction with an illuminant-dependent color correction matrix to achieve accurate color reproduction.

One of ordinary skill in the art appreciates that the color correction matrices shown in table 500 are 3×3 matrices for converting RGB white balanced data into RGB color corrected data. Other sized matrices for converting between other color spaces may also be generated without deviating from the principles and scope of the invention.

According to an embodiment of the invention, only a subset of the color coefficient matrices shown in Table 500 is stored in image sensor apparatus 100 and used to derive an illuminant-dependent color correction matrix. The illuminant-dependent color correction matrix is derived by interpolating the subset of color correction matrices based on a linear relationship between the color correction matrices and the corresponding white balance gains for the candidate illuminants.

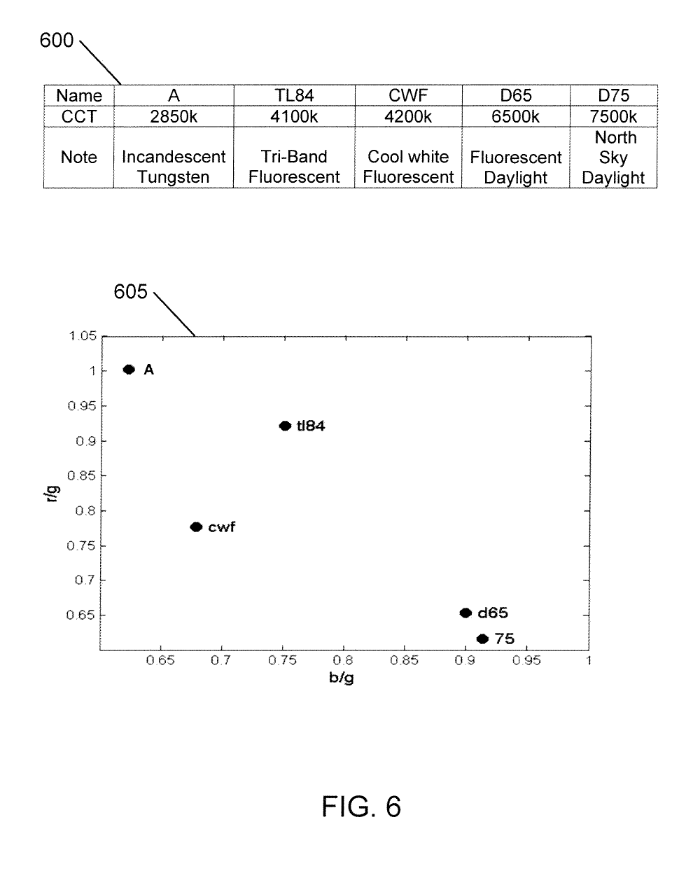

FIG. 6 illustrates a graph showing white balance gains corresponding to the color correction matrices of FIG. 5 according to an embodiment of the invention. Each candidate illuminant is shown with its different color temperatures in table 600 and their different white balance gains in graph 605. As shown in graph 605, the illuminant A and the D65 and D75 illuminants have white balance gains that are the farthest apart. That is, these illuminants span the range of other candidate illuminants, i.e., other candidate illuminants fall in between the A and the D65 and D75 illuminants. These illuminants also correspond to significantly different color temperatures, as shown in table 500.

In one embodiment, the illuminant A and the illuminant D65 are chosen as the subset of candidate illuminants from which to derive an illuminant-dependent color correction matrix 150 for each image captured by image sensor apparatus 100. Accordingly, color correction matrices and white balance gains for the illuminants A and D65 may be stored in memory 120 of image sensor apparatus 100.

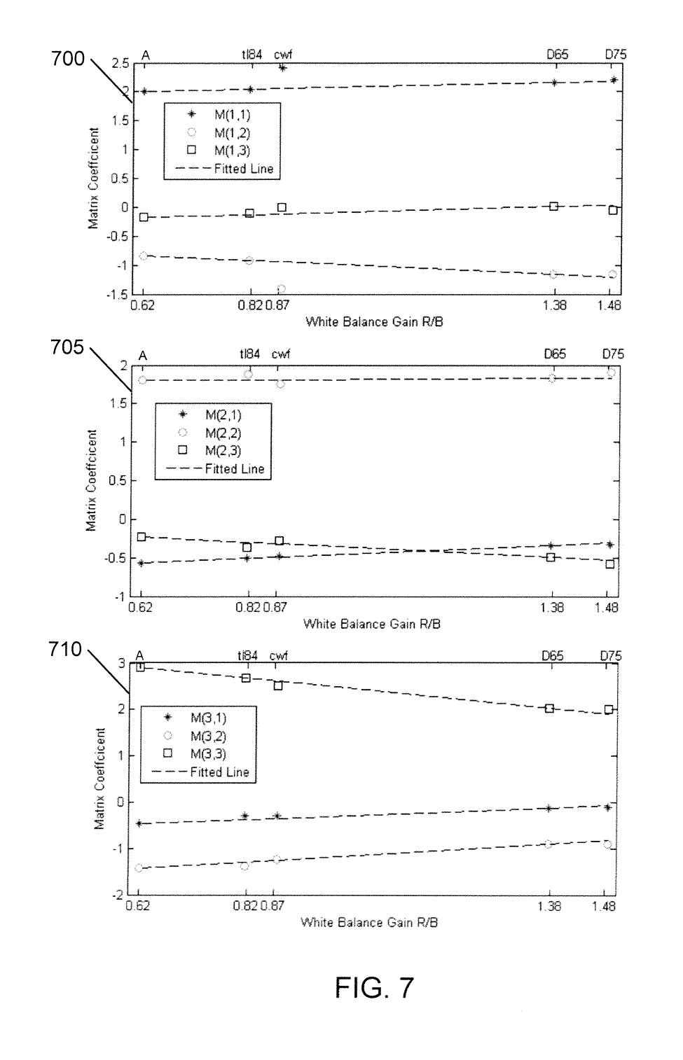

The derivation of the illuminant-dependent color correction matrix 150 is based on a linear relationship between the color correction matrices of the subset of candidate illuminants and their corresponding white balance gains. FIG. 7 illustrates graphs of color correction coefficients and white balance gains corresponding to various candidate illuminants according to an embodiment of the invention. Graph 700 shows the white balance gains for the five candidate illuminants of FIGS. 5-6 versus their color correction coefficients for the first line of their 3×3 color correction matrices. Similarly, graph 705 shows the white balance gains for the five candidate illuminants of FIGS. 5-6 versus their color correction coefficients for the second line of their 3×3 color correction matrices and graph 710 shows the white balance gains for the five candidate illuminants of FIGS. 5-6 versus their color correction coefficients for the third line of their 3×3 color correction matrices.

All graphs 700-710 show a significant linear relationship between the white balance gains and the color correction coefficients of the candidate illuminants. Since these candidate illuminants span a wide range of possible scene illuminants, it is likely that an unknown scene illuminant has color correction coefficients and white balance gains along the lines of graphs 700-710.

That is, any time an image is captured by image sensor apparatus 100 with an unknown scene illuminant, rather than estimating the scene illuminant with a complicated and laborious algorithm, the color correction coefficients corresponding to that illuminant may be simply estimated to fall along the lines of graphs 700-710. This may be accomplished by a simple interpolation or other curve fitting algorithm to derive the color coefficients for the illuminant-dependent color correction matrix 150 every time a new image is captured by image sensor apparatus 100.

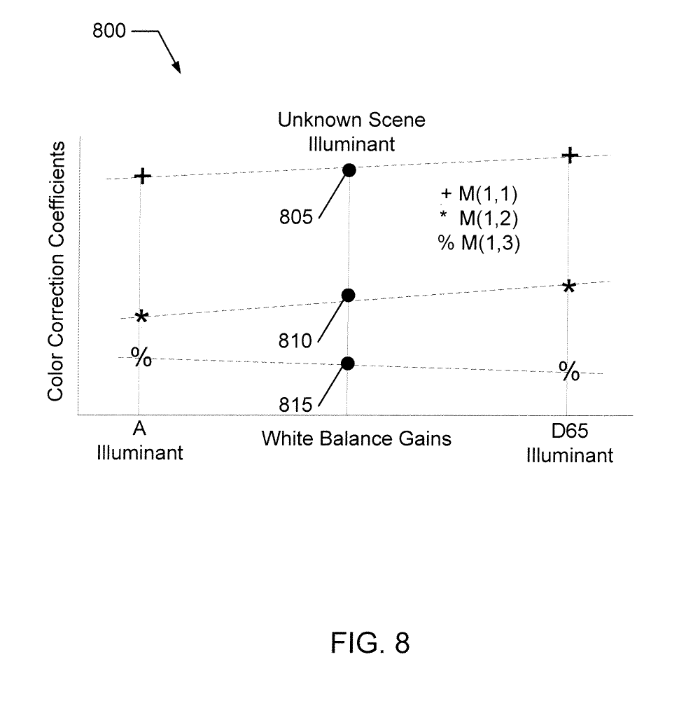

FIG. 8 illustrates the interpolation of color correction coefficients corresponding to a subset of candidate illuminants according to an embodiment of the invention. Graph 800 illustrates the interpolation of color correction coefficients for an unknown scene illuminant based on the color correction coefficients of the illuminant A and the illuminant D65. The A and D65 illuminants, as described above, are significantly different illuminants having significantly different color temperatures. Their color coefficients, as shown in FIG. 7, are some of the farthest apart on the lines represented in graphs 700-710. Any other scene illuminant, including, for example, one of the other candidate illuminants represented in graphs 700-710, may likely fall in between the A and D65 illuminants.

For example, color coefficients 805-815 for an unknown scene illuminant are represented in graph 800 as falling between the color coefficients for the A and D65 illuminants, approximately half-way through them. Unknown color coefficients may be estimated by interpolation, such as linear interpolation. Mathematically, color coefficients for an illuminant-dependent color correction matrix corresponding to an unknown scene illuminant may be estimated by:

$${M}_{unknown} = \frac{{( r / b )}_{unknown} - {( r / b )}_{A}}{{( r / b )}_{D 65} - {( r / b )}_{A}} \times ( {M}_{D 65} - {M}_{A} ) + {M}_{A} \qquad ( 1 )$$

where M_{unknown} represents the illuminant-dependent color correction matrix for the unknown scene illuminant, MD65 represents the color correction matrix for the D65 illuminant, M_{A} represents the color correction matrix for the A illuminant, and (r/b)_{unkown} represents the white balance gain for the unknown illuminant (e.g., computed in white balance module 125 of FIG. 1), (r/b)_{D65} represents the white balance gain for the D65 illuminant and (r/b)_{A} represents the white balance gain for the A illuminant.

By representing the slope ΔM and intercept M₀ of the interpolated line as follows:

$$\begin{matrix}Δ M = \frac{{M}_{D 65} - {M}_{A}}{{( r / b )}_{D 65} - {( r / b )}_{A}} & ( 2 ) \\ {M}_{0} = {M}_{A} - {( r / b )}_{A} \times Δ M & ( 3 )\end{matrix}$$

the illuminant-dependent color correction matrix for the unknown scene illuminant may be derived as follows:

M_{unknown}=(r/b)_{unknown}×ΔM+M₀

Equation (4) above shows how to derive an illuminant-dependent color correction matrix, e.g., matrix 150, for an unknown scene illuminant without estimating the scene illuminant and based only on color correction matrices and white balance gains of a subset of candidate illuminants. One of ordinary skill in the art appreciates that the illuminant-dependent color correction matrix may be derived based only on two candidate illuminants, e.g. the A and D65 illuminants, or on any number of candidate illuminants. Using two candidate illuminants provide good color reproduction without sacrificing computational and storage resources. Using additional candidate illuminants may slightly improve the color reproduction performance with the expense of additional storage and computational resources.

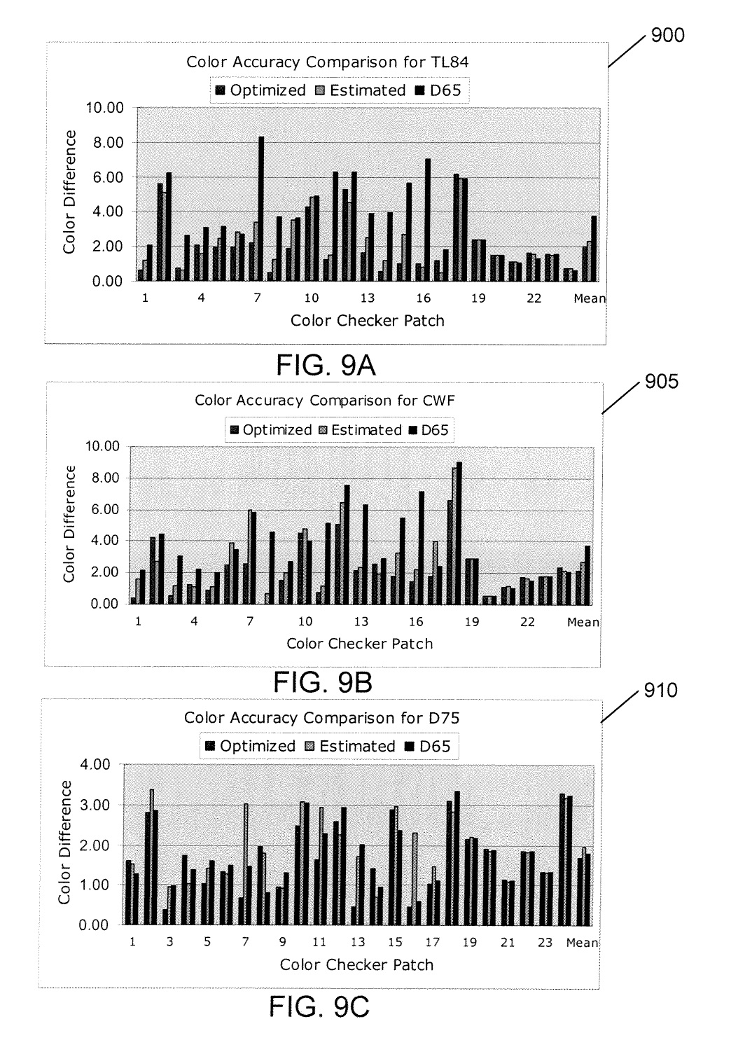

FIGS. 9A-C illustrate the color accuracy performance of illuminant-dependent color correction matrices derived according to an embodiment of the invention for three test illuminants. The test illuminants chosen are the TL84, CWF, and D75 illuminants. Each graph shows the optimized and estimated color correction matrices for each test illuminant as well as the color correction matrix for the D65 illuminant. The optimized color correction matrices for each test illuminant are generated as described above with reference to FIGS. 3-4. The estimated color correction matrices are estimated by interpolation as described above.

Graph 900 shows the color accuracy performance for the TL84 illuminant, graph 905 shows the color accuracy performance for the CWF illuminant, and graph 910 shows the color accuracy performance for the D75 illuminant Graphs 900-910 also show the color accuracy performance of the D65 color correction matrix, that is, it shows the color differences between using the D65 color correction matrix for an unknown scene illuminant. The D65 color correction matrix is shown as it is commonly used in color correction modules of image sensor devices that do not perform illuminant-dependent color correction.

A surprising result from graphs 900-910 that there is little difference between the optimized and estimated color correction matrices for the test illuminants, thereby validating the derivation of illuminant-dependent color correction matrices according to an embodiment of the invention. That is, illuminant-dependent color correction matrices can be estimated to achieve good color accuracy. Further, it can be noted that the estimated color correction matrices achieve significant better performance than the single D65 matrix for the test illuminants. This further reiterates that significant improvement in color correction can be achieved using the proposed derivation of an illuminant-dependent color correction matrix.

Advantageously, the image sensor apparatus of the invention enables color correction to be robustly and accurately performed with low storage and computational requirements. In contrast to traditional approaches to color correction, the estimation of an illuminant-dependent color correction matrix according to embodiments of the invention is capable of achieving high color reproduction performance without major sacrifices in storage and computational resources. The high color reproduction performance is achieved with the unexpected result that color correction information corresponding to only two candidate illuminants is required to derive a robust illuminant-dependent color correction matrix for use with a wide range of scene illuminants.

The foregoing description, for purposes of explanation, used specific nomenclature to provide a thorough understanding of the invention. However, it will be apparent to one skilled in the art that specific details are not required in order to practice the invention.

Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. An image sensor apparatus, comprising:
an image sensor for generating pixel data corresponding to a scene under a scene illuminant;
a memory for storing color correction information corresponding to a subset of candidate illuminants; and
a color correction module for deriving an illuminant-dependent color correction matrix based on the color correction information corresponding to the subset of candidate illuminants and for applying the illuminant-dependent color correction matrix to the pixel data to generate a color corrected digital image.

2. The image sensor apparatus of claim 1, wherein the subset of candidate illuminants comprise at least two significantly different illuminants.

3. The image sensor apparatus of claim 1, wherein the color correction information corresponding to a subset of candidate illuminants comprises color correction information corresponding to at least two candidate illuminants, comprising:
a first color correction matrix and a first white balance gain corresponding to a first candidate illuminant; and
a second color correction matrix and a second white balance gain corresponding to a second candidate illuminant.

4. The image sensor apparatus of claim 3, wherein the color correction module comprises a routine for identifying a linear relationship between the first color correction matrix and the first white balance gain and the second color correction matrix and the second white balance gain.

5. The image sensor apparatus of claim 3, further comprising a white balance module for determining a third white balance gain corresponding to the scene illuminant and for white balancing the pixel data to generate white balanced pixel data.

6. The image sensor apparatus of claim 5, wherein the color correction module comprises an interpolation routine for deriving the illuminant-dependent color correction matrix based on the third white balance gain and the linear relationship between the first color correction matrix and the first white balance gain and the second color correction matrix and the second white balance gain.

7. The image sensor apparatus of claim 1, wherein the subset of candidate illuminants comprises illuminants selected from the list comprising: illuminant A; illuminant series C; illuminant series D; illuminant series F; and illuminant TL84.

8. The image sensor apparatus of claim 3, wherein the first, second, and illuminant-dependent color correction matrices comprise 3×3 matrices for converting RGB data into color corrected RGB data.

9. A method for color correction in an image sensor device, comprising:
capturing pixel data corresponding to a scene under a scene illuminant;
deriving an illuminant-dependent color correction matrix based on color correction information corresponding to a subset of candidate illuminants; and
applying the illuminant-dependent color correction matrix to white balanced pixel data to generate a color corrected digital image.

10. The method of claim 9, wherein deriving an illuminant-dependent color correction matrix based on color correction information corresponding to a subset of candidate illuminants comprises deriving the illuminant-dependent color correction matrix based on:
a first color correction matrix and a first white balance gain corresponding to a first candidate illuminant; and
a second color correction matrix and a second white balance gain corresponding to a second candidate illuminant.

11. The method of claim 10, further comprising generating a plurality of color correction matrices and selecting the first and the second color correction matrices from the plurality of color correction matrices.

12. The method of claim 11, wherein generating a plurality of color correction matrices comprises:
capturing a plurality of pixel data sets corresponding to a training set under a plurality of candidate illuminants, each pixel data set corresponding to a candidate illuminant from the plurality of candidate illuminants;
measuring a plurality of chromaticity data sets for the training set under the plurality of candidate illuminants, each chromaticity data set corresponding to a candidate illuminant from the plurality of candidate illuminants; and
iteratively calculating the plurality of color correction matrices to generate a plurality of color corrected pixel data sets and minimize a weighted color difference between the plurality of chromaticity data sets and the plurality of color corrected pixel data sets.

13. The method of claim 12, further comprising white balancing the plurality of pixel data sets before iteratively calculating the plurality of color correction matrices.

14. The method of claim 13, wherein measuring a plurality of chromaticity data sets comprises measuring a plurality of CIE XYZ coordinates corresponding to the training set under the plurality of candidate illuminants.

15. The method of claim 14, further comprising determining a plurality of white balance gains corresponding to the plurality of candidate illuminants.

16. The method of claim 15, wherein the first and second color correction matrices are selected based on the plurality of white balance gains.

17. The method of claim 16, further comprising identifying a linear relationship between the first color correction matrix and the first white balance gain and the second color correction matrix and the second white balance gain.

18. The method of claim 17, further comprising determining a third white balance gain corresponding to the scene illuminant.

19. The method of claim 18, wherein deriving an illuminant-dependent color correction matrix comprises interpolating the first and the second color correction matrices based on the third white balance gain and the linear relationship between the first color correction matrix and the first white balance gain and the second color correction matrix and the second white balance gain.

20. A processor for use in an image sensor device, comprising:
a white balance routine for determining a white balance gain for pixel data captured by the image sensor device under a scene illuminant; and
a color correction routine for deriving an illuminant-dependent color correction matrix corresponding to the scene illuminant and based on color correction information corresponding to a subset of candidate illuminants.

21. The processor of claim 20, wherein the subset of candidate illuminants comprises at least two significantly different illuminants.

22. The processor of claim 20, wherein the color correction information corresponding to a subset of candidate illuminants comprises information corresponding to at least two candidate illuminants, comprising:
a first color correction matrix and a first white balance gain corresponding to a first candidate illuminant; and
a second color correction matrix and a second white balance gain corresponding to a second candidate illuminant.

23. The processor of claim 22, wherein the color correction routine comprises a interpolation routine for deriving the illuminant-dependent color correction matrix based on the white balance gain for pixel data captured by the image sensor device and a linear relationship between the first color correction matrix and the first white balance gain and the second color correction matrix and the second white balance gain.

24. The processor of claim 20, wherein the color correction routine comprises a routine for applying the illuminant-dependent color correction matrix to white balanced pixel data to generate a color corrected digital image.

25. The processor of claim 22, wherein the first and second color correction matrices are iteratively generated to minimize a color weighted error between acquired data and measured data corresponding to a training set.
